(19) United States
(12) Patent Application Publication
(10) Pub. No.: US 2016/0260124 A1
(43) Pub. Date: Sep. 8, 2016

(54) MEASURING PROMOTION PERFORMANCE OVER ONLINE SOCIAL MEDIA

(71) Applicant: Adobe Systems Incorporated, San Jose, CA (US)

(72) Inventors: Anandhavelu N, Tamil Nadu (IN); Archit Agrawal, Uttar Pradesh (IN); Soumak Datta, Kolkata (IN); Shaik Naseerbaba, Telangana (IN); Ritwik Sinha, Kolkata (IN); Atanu Sinha, Boulder, CO (US)

(73) Assignee: ADOBE SYSTEMS INCORPORATED, San Jose, CA (US)

(21) Appl. No.: 14/635,811

(22) Filed: Mar. 2, 2015

(51) Int. Cl. G06Q 30/02; G06Q 50/00; H04L 29/08

(52) U.S. Cl. CPC G06Q 30/0246; H04L 67/02; G06Q 50/01

(57) ABSTRACT

Techniques described herein relate to calculating the effectiveness or marketing “lift” of online social media promotions (e.g., Tweets® made on Twitter® or postings made on Facebook®), based on the impact that any such promotion is measured to have, after the promotion is made. Key performance indicators (KPI) for online social media marketing efforts may be established or updated based on such calculations. The techniques disclosed herein may also provide a direct way of measuring impact of an online social media promotion on brand awareness among an online social media audience. This may be accomplished while taking into account any effects of other promotions that have been made or are being made contemporaneously on the online social media platform or other non-social media marketing efforts.

### FIELD OF THE DISCLOSURE

This disclosure relates generally to measuring an impact of promotions on marketing related performance indicators, and more specifically to methods that utilize logistic regression for measuring impact of promotions made over online social media.

### BACKGROUND

Online social media platforms including Facebook® and Twitter®, among others, are increasingly used to promote brands, products, and services in marketing campaigns. Consequently, interest in methods for quantifying performance of such marketing campaigns has grown. Conventional techniques for calculating performance for online social media marketing campaigns have relied on counts of easily measured criteria, such as the number of likes, comments, and ReTweets® that a promotion may receive over online social media. Such measurements, however, suffer from biases. Additionally, the Applicant has appreciated that such measurements may be wrong because some measures, such as ReTweets®, may be limited to a small audience since not everyone who talks about a brand may ReTweet® and those that do ReTweet® may do so with minimal attention provided to the subject matter of a promotion.

Another conventional approach for quantifying the impact of an online social media promotion is termed “last click attribution” and includes tracking any purchases made by social media users who have clicked through a promotion in order to purchase an associated product or service. However, users rarely make a purchase of a product or service by clicking through a promotion on online social media, thereby reducing the usefulness of this approach as a measure of marketing campaign effectiveness.

Proposals have been made for alternate ways to measure marketing campaign impact across online social media platforms. One such proposal measures the impact of a Tweet® by assessing the time and effort that a user expends in response to a marketing campaign. This proposal, however, lacks a mechanism to actually quantify user time and effort. Another proposal has various indirect metrics for quantifying marketing impact, including activity, tone, velocity, attention, and participation. These metrics, however, cannot be measured in a statistically accurate manner.

### BRIEF DESCRIPTION OF THE DRAWINGS

FIG. 1 is a flow chart showing acts that may be included in a method to calculate the impact that a promotion made over an online social media platform may have on a marketing performance indicator, according to an embodiment of the present disclosure.

FIG. 2 shows a graphical representation of populations of users from which a test group and a control group may be formed, according to an embodiment of the present disclosure.

FIG. 3 shows fitted probabilities displayed on a Z scale, also known as Wald Z Statistic, and that illustrate the significance of different user features and network features in relation to a test group and a control group, according to an embodiment of the present disclosure.

FIG. 4 shows median values that result from logistic regression performed for a test group and control group in relation to a promotion made over online social media, according to an embodiment of the present disclosure.

FIG. 5 shows an example system for measuring promotion performance over online social media, in accordance with an embodiment of the present disclosure.

### DETAILED DESCRIPTION

Techniques described herein relate to calculating the effectiveness or marketing “lift” of online social media promotions (e.g., Tweets® made on Twitter® or postings made on Facebook®), based on the impact that any such promotion is measured to have, after the promotion is made. Key performance indicators (KPI) for online social media marketing efforts may be established or updated based on such calculations. The techniques disclosed herein may also provide a direct way of measuring impact of an online social media promotion on brand awareness among a social media audience. This may be accomplished, according to some example embodiments, while taking into account any effects of other promotions that have been made or are being made contemporaneously on the online social media platform or other non-social media marketing efforts. In this respect, multiple simultaneous effects are accounted for in quantifying marketing lift that is directly associated with a particular promotion made on an online social media platform. Results of techniques described herein may provide a quantifiable measure of an amount of increased (or decreased) positive mentions that are attributable to a particular online social media promotion.

Various techniques are described herein with reference to measuring impact on a marketing performance indicator for promotions made over online social media. It is, however, to be appreciated that descriptions made with reference to particular online social media platforms are merely exemplary, and that the techniques disclosed herein are not limited to use with any one particular online social media platform. Some non-limiting examples of online social media platforms with which embodiments may be applied include Facebook®, Twitter®, Instagram®, LinkedIn®, Pinterest®, Tumblr®, and Flickr® among others. It is also to be appreciated that promotions made outside of online social media platforms may be assessed according to some embodiments described herein, including promotions made through conventional approaches such as television, radio, and print for which marketing impact may be measured through mentions over online social media sites and other internet forums.

As used herein, the term “handle” refers to an entity having an interest in promoting itself to build awareness, including any goods, services, and/or good will that may be associated with the entity. Non-limiting examples of entities include companies, non-profit organizations, corporations, celebrities, sports figures, politicians, and other individuals having media presence. The term “handle” may additionally refer to the persona or pseudonym associated with such an entity on an online social media platform.

The term “promotion” refers to publicity, advertisement, media exposure or commentary regarding a handle, including any goods, services, and good will that might be associated with the handle. Examples of promotions that may be made on some online social media platforms include Tweets® and ReTweets® made on Twitter®; postings, shares, likes, comments and the like as may be made on Facebook®, Instagram®, LinkedIn®, Pinterest® and other online social media platforms. “Further promotion”, in the context of embodiments that involved online social media, refers to commentary or acknowledgement of a promotion made by another user, such as the ReTweeting® of a Tweet® made by another user and the liking, sharing, or commenting on the posting or comment made by another user.

The term “social media features”, as used herein, refers to characteristics that a user may exhibit on an online social media platform, including but not limited to how active a user is on a social media platform (e.g., user features) and/or a degree to which a user is connected to other users on an online social media platform (e.g., network features).

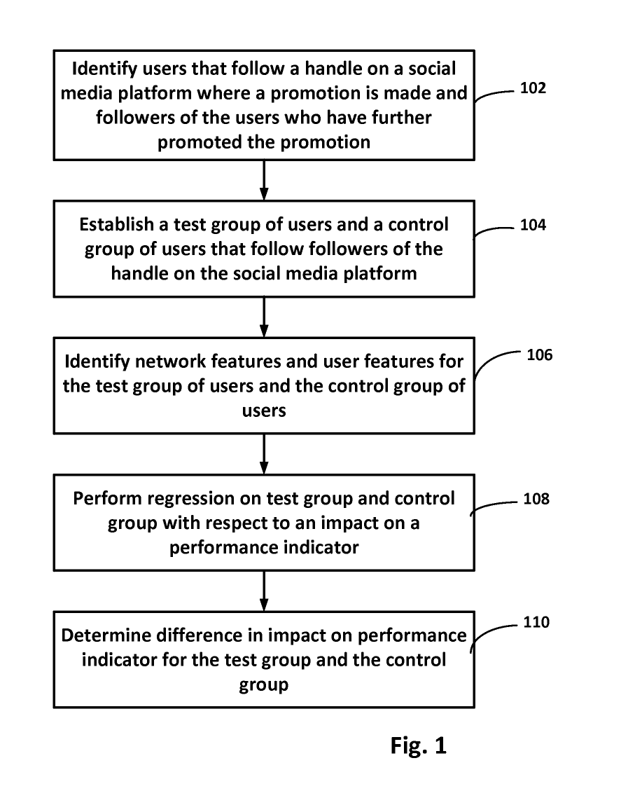

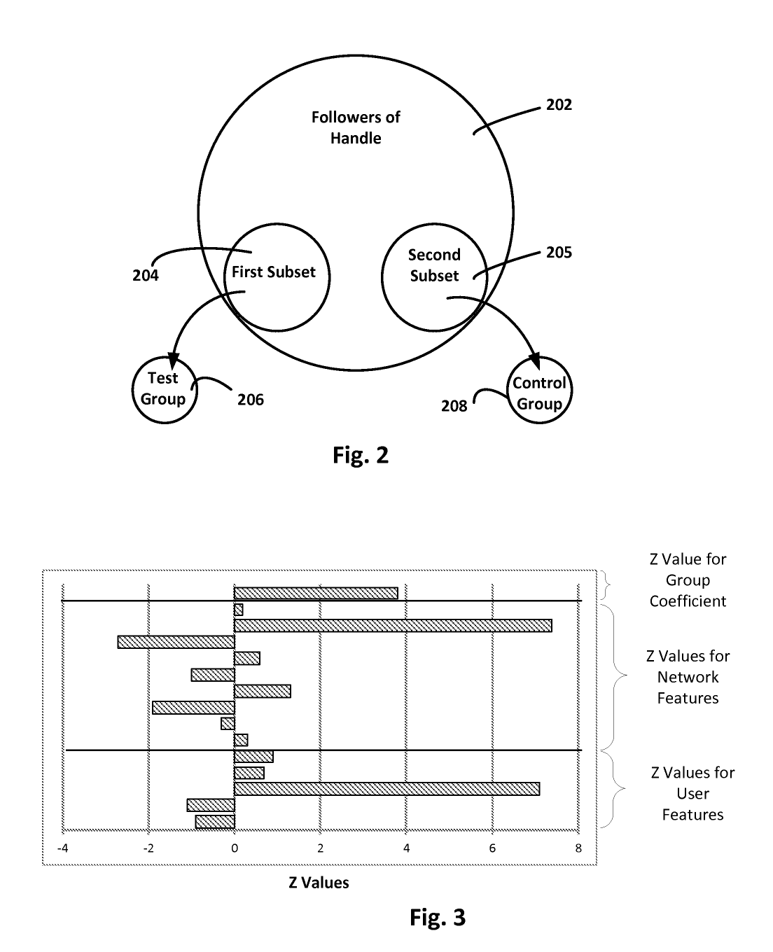

Turn now to the figures and initially FIG. 1, which that shows a high level flow chart of a method that may be used to calculate impact on a performance indicator for a promotion made on an online social media platform and FIG. 2 that shows a graphical representation of users considered for inclusion in the calculation, according to an embodiment.

Initially, users who follow a handle that has made a promotion are identified 102. The followers of the handle may include users that are directly exposed to the promotion made by a handle, such as through a relationship on an online social media platform to the handle. Depending on the language of a particular online social media platform, the users may be termed friends, followers, or “in network” with respect to the handle, although other relationships are also possible as long as the user may be exposed directly to the promotion made by the handle.

The followers of the handle 202 may be divided into a first subset 204 of users that have further promoted the promotion over online social media and a second subset 205 of followers that have abstained from further promoting the promotion. Users may also be identified that are not followers of the handle but that do follow the users who follow the handle. As may be appreciated, some of the users that do not follow the handle but that do follow other users who, in turn, follow the handle, may have been exposed to further promotions of the promotion, such as ReTweets®, comments or likes that refer to the promotion.

A test group used to assess the impact of a promotion by a handle may be established 104 from users that follow followers of the handle 104, and specifically from the first subset 204 of users that have made further promotions. Different approaches may be used to establish the test group. According to one approach, followers of the first subset of users 204 are included in the test group as they are identified. This process may continue until the test group has attained a desired size without further consideration as to whether a user should be included in test group 206. According to some embodiments, random sampling may be used to prevent or reduce self-selection bias in selecting members of the first subset 204 for inclusion in the test group 206. Alternately, steps may be taken so that followers of members of the first subset that also follow the handle are excluded from the test group. Excluding users that also follow the handle in this respect may approximate random sampling to aid in minimizing bias, and may be accomplished with less effort than random sampling. Users that are excluded from the test group 206 for also being followers of the handle may be returned to the first subset 204 for potential future selection in the test group, according to some embodiments. Such an approach is consistent with the statistical technique of sampling with replacement and may be used to minimize covariance and/or dependence between the test group and the control group. It is to be appreciated, however, that other techniques may also be employed, including but not limited to sampling without replacement.

The control group 208 may be formed in a manner that mirrors the formation of the test group 206, but with users selected from followers of the second subset 205 of users who have abstained from further promoting the promotion made by the handler. Users may be selected for the control group 208 from the second subset without further consideration as to membership in the control group until the control group is of a desired size. The desired size of the control group may be similar to or the same as the size of the test group, according to some embodiments. As with formation of the test group, techniques may be performed to prevent self-selection bias, including random sampling. According to an embodiment, followers of the second subset that are also followers of the handle may be excluded from inclusion in the control group with the excluded users being made available for potential selection again (i.e., sampling with replacement). Other techniques may be employed, additionally or alternately, to prevent users that have been exposed to the promotion from being selected for the control 208, such as by preventing members of both 202 and 204 from being included in control group 208.

User features may be identified to quantify how active a user of either the test or control group is on social media 106. Broadly speaking, user features may indicate the degree of presence or activity that a user may have on an online social media platform, and thus the likelihood that a user may have been seen or commented on a promotion, all else constant. User features may include the number of followers that a user has, the number of friends or connections that user has, the number of statuses, comments, likes, posts, and/or shares that a user has performed within an identified time period, and other features indicative of online social media presence.

For users of the test and/or control groups, network features may additionally or alternately be identified 106 that relate to activities made by network connections of a user in relation to the topic of the promotion. Network features may be used to quantify bias for members of both the test and control group. Examples of a network features that may be identified for each user includes the number of friends that the user has outside of both of the test group and control group who have made a promotion about a similar topics as that of the promotion that is being assessed. Another example includes the number of followers of friends that have previously promoted the topic of the promotion that is being assessed. The number of friends that a user has in the opposite group (i.e., test group or control group) that have previously made a promotion on the same topic as the promotion that is being assessed the topic before a user is yet another network feature. Another potential network feature includes the number of friends that a user has in the same group (i.e., test group or control group) that have made a promotion about the same topic as the promotion being assessed.

User features and network features, among other potential online social media features, may be gathered through different techniques, depending on features of the online social media platform where a promotion is made. According to an example embodiment, user information and features may be gathered directly from an online social media platform where connections exist between the handle and the user, depending on online social media platform settings. Web crawlers may, additionally or alternately, be used to gather information that cannot be located directly through online social media connections.

Regression may be performed 108 on the test group and the control group for a performance indicator in order to quantify an impact on brand mentions or brand awareness. According to an embodiment, logistic regression is performed with brand mentions treated as a dependent variable and the test and control groups treated as the independent variable while controlling for any identified user and network features. Equations 1 below reflects logistic regression performed on a test group and a control group, respectively, with user features and network features associated with the regression coefficients. Although logistic regression is discussed herein with respect to an example embodiment, it is to be appreciated other types of regression are also contemplated.

Performance=Group+Group*(User Features+Network Features) Equation 1
Where:
Group is a boolean variable taking Test and Control as Values
User Features is a vector or list of collected user features
Network Features is a vector or list of collected network features

Fitted probabilities may be obtained for the test and control groups, and displayed on a normalized plot that illustrates the impact of each user and network feature on brand mentions for both a test group and a control group. FIG. 3 shows one example embodiment of fitted probabilities displayed on a Z probability scale, showing the significance of different user feature and network features individually and for each of the test group and control group. Whether a particular feature had a positive or negative impact on brand mentions, as well as the degree of any impact may be viewed from in the plot of FIG. 3.

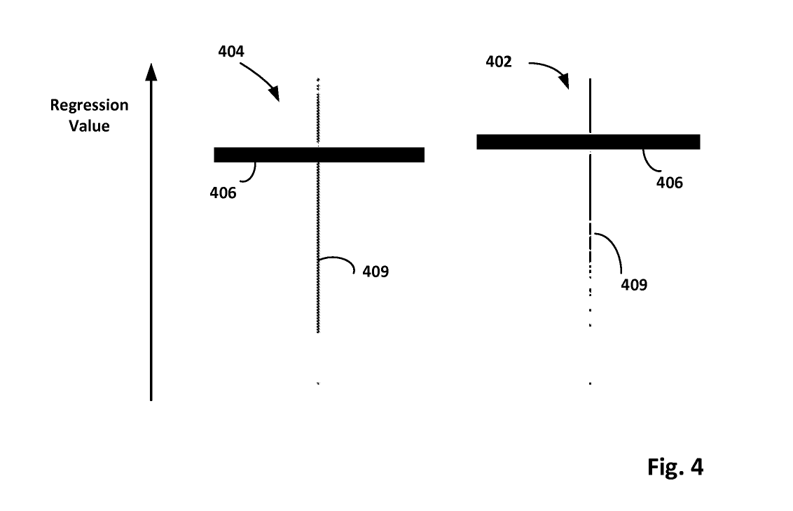

Median values associated with regression of both the test and control group may be calculated to provide value for summary comparison. FIG. 4 shows one example of how median values for a test group and control group may be illustrated to identify impact of a promotion on a performance indicator, such as further promotions or brand mentions. In the illustrated plot, the test group 402 has a higher median value than the control group 404, as shown by the relative position of horizontal bars 406. Values associated with each feature that collectively define the mean are represented on vertical plots 409 in the plot of FIG. 4.

It is to be appreciated that logistic regression is but one approach that may be utilized to assess impact of a promotion made by a handle over an online social media platform, and that other approaches are also contemplated. According to other example embodiments, approaches may be based on linear regression models, generalized linear models, decision trees (e.g., random forest decision trees), genetic algorithms, and/or neural networks, to name a few. In any such approaches, the acts of identifying followers of a handle, defining subsets of followers, test groups, and/or control groups are to be understood to be performed in a manner that is consistent with the associated approach. By way of non-limiting example, in the case of a random forest approach, individual weights may be used to calculate effect sizes in place of the regression coefficients associated with logistic regression, as shown above in Equation 1.

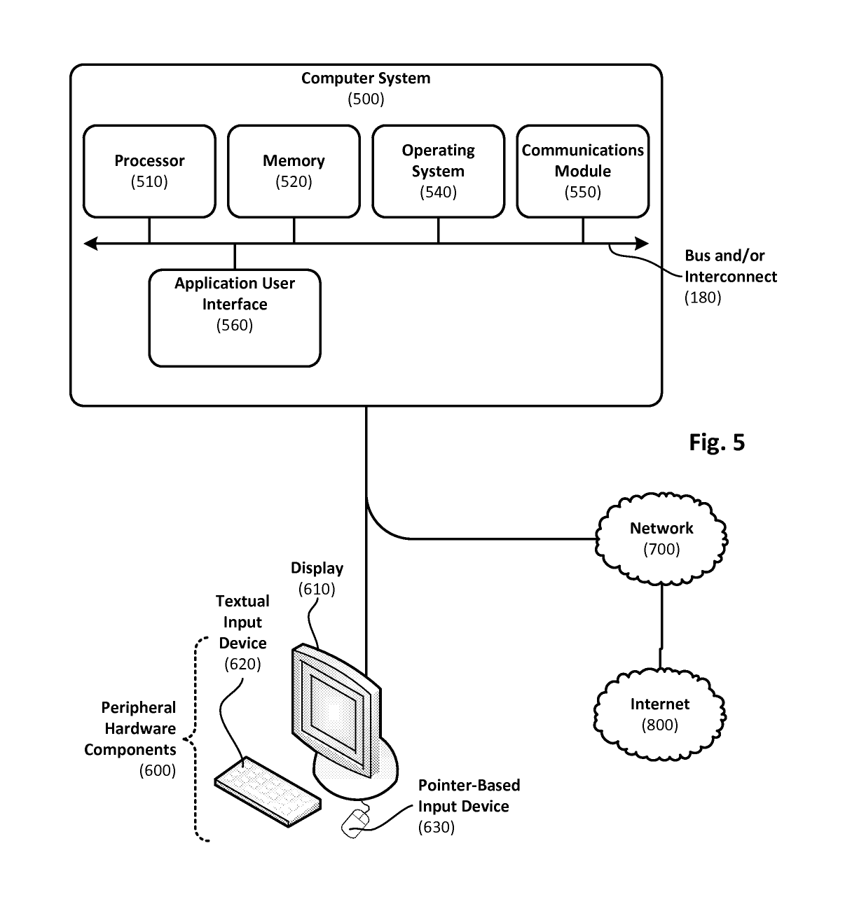

FIG. 5 is a block diagram schematically illustrating selected components of an example computer system 500 that can be used to implement a method of measuring performance of a marketing promotion, according to some embodiments. Computer system 500 may comprise, for example, one or more devices selected from a desktop computer, a laptop computer, a workstation, a tablet computer, a smartphone, a handheld computer, a set-top box, an enterprise class server, or any other such computing device. A combination of different devices may be used in certain embodiments. In the illustrated embodiment, computer system 100 includes, among other things, a processor 510, a memory 520, an operating system 540, a communications module 550, an application user interface 560, and a local image repository 570. As can be further seen, a bus and/or interconnect 580 is also provided to allow for inter- and intra-device communications using, for example, communications module 550.

Depending on the particular type of device used for implementation, computer system 600 is optionally coupled to or otherwise implemented in conjunction with one or more peripheral hardware components 600. Examples of peripheral hardware components 600 include a display 610, a textual input device 620 (such as a keyboard), and a pointer-based input device 630 (such as a mouse). One or more other input/output devices, such as a touch sensitive display, a speaker, a printer, or a microphone, can be used in other embodiments. For example, in a particular alternative embodiment wherein computer system 500 is implemented in the form of a tablet computer, functionality associated with the particular peripheral hardware components 600 illustrated in FIG. 5 is provided instead by a touch sensitive surface that forms part of the tablet computer. In general, computer system 500 may be coupled to a network 700 to allow for communications with other computing devices or resources, such as the internet 800 for searching online social media platforms and the internet 800 in general for user information and social media features. Other componentry and functionality not reflected in the schematic block diagram of FIG. 5 will be apparent in light of this disclosure, and thus it will be appreciated that other embodiments are not limited to any particular hardware configuration.

Processor 510 can be any suitable processor, and may include one or more coprocessors or controllers, such as an audio processor or a graphics processing unit, to assist in control and processing operations associated with computer system 500. Memory 520 can be implemented using any suitable type of digital storage, such as one or more of a disc drive, a universal serial bus (USB) drive, flash memory, and/or random access memory (RAM). Operating system 540 may comprise any suitable operating system, such as Google Android (Google Inc., Mountain View, Calif.), Microsoft Windows (Microsoft Corp., Redmond, Wash.), or Apple OS X (Apple Inc., Cupertino, Calif.). As will be appreciated in light of this disclosure, the techniques provided herein can be implemented without regard to the particular operating system provided in conjunction with computer system 500, and therefore may also be implemented using any suitable existing or subsequently-developed platform. Communications module 550 can be any appropriate network chip or chipset which allows for wired and/or wireless connection to other components of computer system 500, and/or to network 800, thereby enabling computer system 500 to communicate with other local and/or remote computer systems, servers, and/or resources.

Application user interface 560 is configured to provide a user interface that is capable of providing information to, and receiving information from, a user of computer system 500. The provided user interface can be implemented using, or otherwise used in conjunction with, peripheral hardware components 600. Application user interface 560 can be installed local to computer system 500, as shown in the example embodiment of FIG. 5. However, in alternative embodiments computer system 500 is implemented in a client-server arrangement wherein at least some potions of application user interface 560 are provided to computer system 500 using an applet (for example, a JavaScript applet) or other downloadable module. Such a remotely-provisioned module can be provided in real-time in response to a request from computer system 500 for access to a server having resources that are of interest to the user of computer system 500. Examples of such resources include a cloud-based repository of images or other content that the user wishes to manipulate. The server, if applicable, may be local to network 700 or may be remotely coupled to network 700 by one or more other networks or communication channels. In any such standalone or networked computing scenarios, application user interface 560 can be implemented with any suitable combination of technologies that allow a user to interact with computer system 500. In one particular example embodiment application user interface 560 is provided by an image editing software application such as Adobe Photoshop.

The embodiments disclosed herein can be implemented in various forms of hardware, software, firmware, or special purpose processors. For example, in one embodiment a non-transitory computer readable medium has instructions encoded thereon that, when executed by one or more processors, cause one or more of the digital image manipulation methodologies disclosed herein to be implemented. The instructions can be encoded using one or more suitable programming languages, such as C, C++, object-oriented C, JavaScript, Visual Basic .NET, BASIC, or alternatively, using custom or proprietary instruction sets. Such instructions can be provided in the form of one or more computer software applications or applets that are tangibly embodied on a memory device, and that can be executed by a computer having any suitable architecture. In one embodiment the system can be hosted on a given website and implemented using JavaScript or another suitable browser-based technology.

The functionalities disclosed herein can optionally be incorporated into a variety of different software applications, such as image editing software applications, word processing applications, desktop publishing applications, and presentation applications. The computer software applications disclosed herein may include a number of different modules, sub-modules, or other components of distinct functionality, and can provide information to, or receive information from, still other components and services. These modules can be used, for example, to communicate with peripheral hardware components 600, networked storage resources such as networked image repository 800, or other external components. More generally, other components and functionality not reflected in the illustrations will be apparent in light of this disclosure, and it will be appreciated that the present disclosure is not intended to be limited to any particular hardware or software configuration. Thus in other embodiments the components illustrated in FIG. 5 may comprise additional, fewer, or alternative subcomponents.

The aforementioned non-transitory computer readable medium may be any suitable medium for storing digital information, such as a hard drive, a server, a flash memory, or random access memory. In alternative embodiments, the computer and modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input and output ports for receiving and transmitting data, respectively, and a number of embedded routines for carrying out the various functionalities disclosed herein. It will be apparent that any suitable combination of hardware, software, and firmware can be used, and that the present disclosure is not intended to be limited to any particular system architecture.

Numerous variations and configurations will be apparent in light of this disclosure. For instance one example embodiment provides a computer implemented method of measuring performance of a promotion made by a handle in an online social media platform. The method comprises identifying followers of the handle on the online social media platform and defining a first subset that includes followers of the handle that have performed further promotion of the promotion. A test group is defined that includes followers of members of the first subset. A control group is defined that includes followers of the handle that have abstained from performing further promotion of the promotion. Online social media features are collected for members of the test group and for members of the control group. Analysisis performed on the further promotions in view of the online social media features for the test group and the control group to measure performance of the promotion. Analysis of the further promotions may include performing logistic regression on the further promotions in view of the online social media features for the test group and the control group to measure performance of the promotion. The control group may be defined from a second subset of the followers of the handle that have abstained from further promoting the promotion made by the handle in the online social media platform. This may include excluding members from the control group that are also followers of the handle, such as by sampling with replacement from the first subset, according to some example embodiments. The test group may be defined to excluding members from the test group that are also followers of the handle, such as by sampling with replacement from the first subset. Collecting online social media features may include online social media features for members of the test group and for members of the control group.

Another example embodiment provides a system that includes storage and a processor operatively coupled to the storage. The processor is configured to execute instructions stored in the storage that when executed cause the processor to carry out a process that includes identifying followers of the handle on the online social media platform and defining a first subset that includes followers of the handle that have performed further promotion of the promotion. A test group is defined that includes followers of members of the first subset. A control group is defined that includes followers of the handle that have abstained from performing further promotion of the promotion. Online social media features are collected for members of the test group and for members of the control group. Analysis is performed on the further promotions in view of the online social media features for the test group and the control group to measure performance of the promotion. Analysis of the further promotions may include performing logistic regression on the further promotions in view of the online social media features for the test group and the control group to measure performance of the promotion. The control group may be defined to exclude members from the control group that are also followers of the handle by sampling with replacement from the first subset, such as by sampling with replacement from the first subset. Online social media features may be collected for members of the test group and for members of the control group, wherein the user features include at least one user feature selected from a group consisting of a count of connections and a count of statuses. The count of connections may include one or more of a count of friends and a count of followers on the online social media platform. Collecting online social media features may include collecting network features for members of the test group and for members of the control group, where the network features include one or more network feature selected from a group consisting of a number of friends that a user has outside both the test group and the control group that have made a prior promotion on a topic related the promotion made by the handle; a number of followers of friends that have made a prior promotion on a topic related to the promotion made by the handle; a number of friends in an opposite of the test group and the control group of a user that have made a prior promotion on a topic related to the promotion made by the handle; and a number of friends in a common group of the test group and the control group of a user that have made a prior promotion on a topic related to the promotion made by the handle.

According to another example embodiment, a non-transient computer program product has instructions encoded thereon that when executed by one or more processors cause a process to be carried out. The process includes identifying followers of the handle on the online social media platform with a web crawler and defining a first subset that includes followers of the handle that have performed further promotion of the promotion. A test group is defined that includes followers of members of the first subset. A second subset is defined that includes followers of the handle that have abstained from further promotion of the promotion. A control group is defined that includes followers of members of the second subset. Online social media features are collected for members of the test group and for members of the control group. Analysis is performed on the further promotions in view of the online social media features for the test group and the control group to measure performance of the promotion. Analysis of the further promotions may include performing logistic regression on the further promotions in view of the online social media features for the test group and the control group to measure performance of the promotion. The control group may be defined to exclude members from the control group that are also followers of the handle by sampling with replacement from the first subset. The test group may be defined to exclude members from the test group that are also followers of the handle by sampling with replacement from the first subset. Online social media features may be collected for members of the test group and for members of the control group. The user features may include one or more of a count of friends; a count of followers, and a count of postings on the online social media platform. Collecting online social media features may include collecting network features for members of the test group and for members of the control group.

The foregoing detailed description has been presented for the purposes of illustration and description. It is not intended to be exhaustive or to limit the invention(s) to the particular disclosed embodiments. Many modifications and variations are possible in light of this disclosure. Thus it is intended that the scope of the invention(s) be limited not by this detailed description, but rather by the claims appended hereto.

1. A computer implemented method of measuring performance of a promotion made by a handle in an online social media platform, the method comprising:
identifying, by a computer processor, followers of the handle on the online social media platform;
defining, by the computer processor, a first subset that includes followers of the handle that have performed further promotion of the promotion;
defining, by the computer processor, a test group that includes followers of members of the first subset;
defining, by the computer processor, a control group that includes followers of the handle that have abstained from performing further promotion of the promotion;
collecting, by the computer processor, online social media features for members of the test group and for members of the control group; and
analyzing, by the computer processor, the further promotions in view of the online social media features for the test group and the control group to measure performance of the promotion.

2. The method of claim 1, wherein analyzing the further promotions includes performing logistic regression on the further promotions in view of the online social media features for the test group and the control group to measure performance of the promotion.

3. The method of claim 2, wherein defining the control group includes defining the control group from a second subset of the followers of the handle that have abstained from further promoting the promotion made by the handle in the online social media platform.

4. The method of claim 3, wherein defining the control group includes excluding members from the control group that are also followers of the handle.

5. The method of claim 4, wherein defining the control group includes defining the control group by sampling with replacement from the first subset.

6. The method of claim 2, wherein defining the test group includes excluding members from the test group that are also followers of the handle.

7. The method of claim 2, wherein collecting online social media features includes collecting user features for members of the test group and the control group.

8. The method of claim 2, wherein collecting online social media features includes collecting network features for members of the test group and the control group.

9. A system comprising:
a storage; and
a computer processor operatively coupled to the storage, the computer processor configured to execute instructions stored in the storage that when executed cause the computer processor to carry out a process comprising:
identifying followers of the handle on the online social media platform with a web crawler;
defining a first subset that includes followers of the handle that have performed further promotion of the promotion;
defining a test group that includes followers of members of the first subset;
defining a control group that includes followers of the handle that have abstained from performing further promotion of the promotion;
collecting online social media features for members of the test group and for members of the control group; and
analyzing the further promotions in view of the online social media features for the test group and the control group to measure performance of the promotion.

10. The system of claim 9, wherein defining the control group includes excluding members from the control group that are also followers of the handle by sampling with replacement from the first subset.

11. The system of claim 9, wherein analyzing the further promotions includes performing logistic regression on the further promotions in view of the online social media features for the test group and the control group to measure performance of the promotion.

12. The system of claim 9, wherein collecting online social media features includes collecting user features for members of the test group and for members of the control group, wherein the user features include at least one user feature selected from a group consisting of a count of connections and a count of statuses.

13. The system of claim 12, wherein the count of connections includes one or more of a count of friends and a count of followers on the online social media platform.

14. The system of claim 12, wherein collecting online social media features includes collecting network features for members of the test group and for members of the control group, the network features including one or more network feature selected from a group consisting of:
a number of friends that a user has outside both the test group and the control group that have made a prior promotion on a topic related the promotion made by the handle;
a number of followers of friends that have made a prior promotion on a topic related to the promotion made by the handle;
a number of friends in an opposite of the test group and the control group of a user that have made a prior promotion on a topic related to the promotion made by the handle; and
a number of friends in a common group of the test group and the control group of a user that have made a prior promotion on a topic related to the promotion made by the handle.

15. A non-transitory computer program product having instructions encoded thereon that when executed by one or more computer processors cause a process to be carried out, the process comprising:
identifying followers of the handle on the online social media platform with a web crawler;
defining a first subset that includes followers of the handle that have performed further promotion of the promotion;
defining a test group that includes followers of members of the first subset;
defining a second subset that includes followers of the handle that have abstained from further promotion of the promotion;
defining a control group that includes followers of members of the second subset;
collecting online social media features for members of the test group and for members of the control group; and
analyzing the further promotions in view of the online social media features for the test group and the control group to measure performance of the promotion.

16. The non-transitory computer program product of claim 15, wherein defining the control group includes excluding members from the control group that are also followers of the handle by sampling with replacement from the first subset.

17. The non-transitory computer program product of claim 15, wherein defining the test group includes excluding members from the test group that are also followers of the handle by sampling with replacement from the first subset.

18. The non-transitory computer program product of claim 15, wherein collecting online social media features includes collecting user features for members of the test group and for members of the control group.

19. The non-transitory computer program product of claim 18, wherein the user features include one or more of a count of friends; a count of followers, and a count of postings on the online social media platform.

20. The non-transitory computer program product of claim 15, wherein analyzing the further promotions includes performing logistic regression on the further promotions in view of the online social media features for the test group and the control group to measure performance of the promotion.
